(19) United States
(12) Patent Application Publication
(10) Pub. No.: US 2006/0096101 A1
(43) Pub. Date: May 11, 2006

(54) Drywall corner bead cutting device

(76) Inventor: Barbara Winkler, Lincoln, NE (US)

Correspondence Address: Adam H. Jacobs;The Law Offices of Adam H. Jacobs, Suite 726, 1904 Farnam Street, Omaha, NE, 68102, US

(21) Appl. No.: 10/984,281

(22) Filed: Nov. 8, 2004

(51) Int. Cl. B26B 3/08; B26B 1/00

(52) U.S. Cl. 30/136; 30/292; 30/169; 30/360

(57) ABSTRACT

A drywall corner bead cutting device includes a drywall corner bead retaining body having a cross-sectional shape approximately similar to the cross-sectional shape of the drywall corner bead to be cut, the retaining body including a longitudinally extended top wall plate and inner and outer base wall retaining elements for releasably retaining the drywall corner bead within the retaining body and at least one cutting blade assembly movably mounted on the retaining body which includes a handle and a cutting blade which extends through the retaining body to cut the drywall corner bead on a diagonal to permit the cut sections of drywall corner bead to be butted against one another to form a generally seamless joint.

### BACKGROUND OF THE INVENTION

1. Technical Field

The present invention is directed to drywalling tools and, more particularly, to a drywall corner bead cutting device which includes a drywall corner bead retaining body having a cross-sectional shape approximately similar to the cross-sectional shape of the drywall corner bead to be cut, the retaining body including a longitudinally extended top wall plate and inner and outer base wall retainers for releasably retaining the drywall corner bead within the retaining body and at least one cutting blade assembly movably mounted on the retaining body which includes a handle and a cutting blade which extends through the retaining body to cut the drywall corner bead on a diagonal to permit the cut sections of drywall corner bead to be butted against one another at a joint.

2. Description of the Prior Art

A vast majority of buildings which are constructed in the United States use drywall to form the interior walls of the building. Briefly, drywall is a sheet material consisting of a uniform layer of gypsum sandwiched between facings of paper which can used as an interior wall covering which can be painted or covered with decorative paper or paneling once installed over the framing for the building. Drywall is generally used for interior walls of buildings as it is relatively inexpensive to manufacture and can be quickly and easily installed in a variety of room configurations. Once of the problems encountered in the use of drywall, however, is that the drywall must be fitted around windows which are built into the sides of the building, thus requiring sections of the drywall to be cut out to permit the window to be seen therethrough. These cut out sections must then be cleaned up to enhance the appearance of the interior wall and until relatively recently, this was done by merely plastering the edges of the drywall to the window frame to even out the edges of the drywall adjacent the window frame.

A relatively recent innovation in drywall construction, however, is the advent of the drywall corner bead, also known as the bullnose corner bead. This generally consists of an extruded length of plastic sheet having a length of approximately 24″ to 48″ and a width of approximately 2″ to 4″ with the center top section of the corner bead having a generally arcuate cross-sectional shape with left and right generally perpendicular sidewalls extending outward from the center section. In use, the drywall corner bead is placed over the intersection between the drywall edge and the window frame such that the top center curved section is positioned over the protruding corner of the cut drywall section. The drywall corner bead is then affixed to the drywall and to the window frame and then would be plastered over thus providing a curved corner adjacent the window which is aesthetically pleasing and far more durable than the cut corner of the drywall section.

One of the disadvantages of the use of drywall corner bead, however, is that the corner angles of the window frame must be accommodated by the drywall corner bead to permit the adjacent sections of the drywall corner bead to butt against one another to provide a seamless and generally continuous wall surface adjacent the window. The cutting of the drywall corner bead to correctly produce these corner joints can be quite difficult, however, and cutters without much experience often make mistakes in making the corner cuts. Briefly, the procedure for cutting the drywall corner bead would include cutting the drywall corner bead to the desired length which corresponds with the inside height or width of the window then taking a pattern which shows how the cut should be made and positioning it adjacent the drywall corner bead. A pencil or other such marking device would then be used to draw a line on the drywall corner bead as delineated by the pattern positioned adjacent the drywall corner bead, the pattern would be placed to the side and the cutter would then use a pair of snips or the like to cut along the drawing line to produce the corner for the one section of drywall corner bead. This must be done for each corner of the window, which means a total of eight cuts must be made to the four sections of the drywall corner bead to produce the desired window frame result, with each cut including each of the above-described steps. Once the process is completed, the drywall corner bead would be placed on the drywall and window frame and affixed in position.

Of course, this process is very time consuming and the final product is only as good as the person following the pencil line with the snips. There is enormous variation in the skill level of persons practicing drywalling, and it is clear that the above-described process provides many opportunities for mistakes to be made which would result in the need for the cutter to begin again, thus increasing the length of time needed to complete the process and resulting in far more waste due to production of unuseable sections. There is therefore a need for a cutting device which will eliminate many of the above-described steps yet will produce very accurate and precise results each and every time the cutting device is used.

Therefore, an object of the present invention is to provide an improved drywall corner bead cutting device.

Another object of the present invention is to provide a drywall corner bead cutting device which includes a longitudinally extended top wall plate having a top section with a generally arcuate cross-sectional shape and lower inner and outer wall plate sections extending downwards and respectively inwards and outwards from the top section to form a top wall plate having approximately the same cross-sectional shape as the drywall corner bead which will be cut by the present invention.

Another object of the present invention is to provide a drywall corner bead cutting device which includes at least one cutting blade assembly movably mounted on the retaining body which includes a cutting blade mounted on a handle, the cutting blade extending through the top wall plate to cut the drywall corner bead positioned there within, the cut being made quickly and accurately to produce excellent results.

Another object of the present invention is to provide an improved drywall corner bead cutting device which may be quickly and easily used even by novice drywall cutters in order to provide far more consistent and acceptable cutting results regardless of the skill level of the user of the present invention.

Another object of the present invention is to provide an improved drywall corner bead cutting device which includes two cutting blade assemblies, one designed for right-hand cuts and one designed for left-hand cuts, in order to permit use of the present invention regardless of the direction of cut desired to complete the drywall corner bead framing of the window.

Finally, an object of the present invention is to provide an improved drywall corner bead cutting device which is relatively simple in construction and is safe, durable and efficient in use.

### SUMMARY OF THE INVENTION

The present invention provides a drywall corner bead cutting device having a drywall corner bead retaining body which includes a longitudinally extended top wall plate having a top section having a generally arcuate cross-sectional shape, a lower inner wall plate section extending downwards and inwards from the top section and a lower outer wall plate section extending downwards and outwards from the top section. The lower inner and lower outer wall plate sections extend generally perpendicular to one another and the top wall plate further includes at least one generally diagonal cutting blade slot formed in the top wall plate and extending therethrough. The retaining body further includes an inner base wall retention device such as a plate mounted on the lower inner wall plate section generally adjacent the lower portion thereof and generally extending towards the lower outer wall plate section and an outer base wall retention device such as a plate mounted on the lower outer wall plate section generally adjacent the lower portion thereof and generally extending towards the lower inner wall plate section. The retaining body further includes a retaining body support handle mounted on the retaining body and extending outwards therefrom.

At least one cutting blade assembly is movably mounted on the drywall corner bead retaining body. The cutting blade assembly includes a handle movably mounted on the retaining body, the handle having an outer gripping section and an inner blade mounting section positioned generally adjacent the top wall plate of the retaining body and a cutting blade mounted on the blade mounting section of the handle, the cutting blade being generally aligned with the generally diagonal cutting blade slot in the top wall plate. The cutting blade of the cutting blade assembly is operative to cut a drywall corner bead extended into the drywall corner bead retaining body via movement of the handle to drive the cutting blade downwards into a drywall corner bead to divide the drywall corner bead into sections with the cut being formed to permit two drywall corner beads to be abutted to one another in generally perpendicular alignment.

The present invention as thus described provides many improvements to the drywall corner bead cutting methods which were previously used. For example, the cutting skill level of the drywaller becomes less important as the present invention is designed to make accurate, repeatable cuts each and every time the invention is used. Also, because the drywall corner bead is slid into the invention, the correct positioning of the drywall corner bead within the invention for the cut can be accurately determined after the initial measurement is made, thus greatly reducing the possibility of an incorrect cut at an incorrect location being made. Furthermore, because the cutting blade of the present invention is movably mounted to the retaining body, it is not used in a “freehand” manner, thus greatly reducing the possibility for injury which often occurs when using a sharp cutting blade to cut a piece of plastic such as the drywall corner bead. Finally, because the present invention includes relatively few moving parts, the expected useable life span for the invention is quite long and it should be relatively inexpensive to manufacture, thus making it available for a vast majority of drywall erectors in the industry. It is thus seen that the present invention provides a substantial improvement over those devices and methods found in the prior art.

### BRIEF DESCRIPTION OF THE DRAWINGS

FIG. 1 is a perspective view of the drywall corner bead cutting device of the present invention;

FIG. 2 is a top plan elevational view of the present invention showing the positioning of the cutting blade assemblies mounted thereon;

FIGS. 3a and 3b are detailed side elevational views showing the blade cutting a drywall corner bead positioned within the retaining body;

FIG. 4 is a detailed perspective view of two drywall corner beads after they are cut by the present invention being positioned adjacent one another in a generally perpendicular arrangement;

FIG. 5 is a perspective view of a standard window showing how the cut drywall corner beads are positioned around the inner frame of the window to connect to the surrounding drywall sections; and

FIG. 6 is a perspective view of an alternative embodiment of the present invention having only a single cutting blade.

### DESCRIPTION OF THE PREFERRED EMBODIMENT

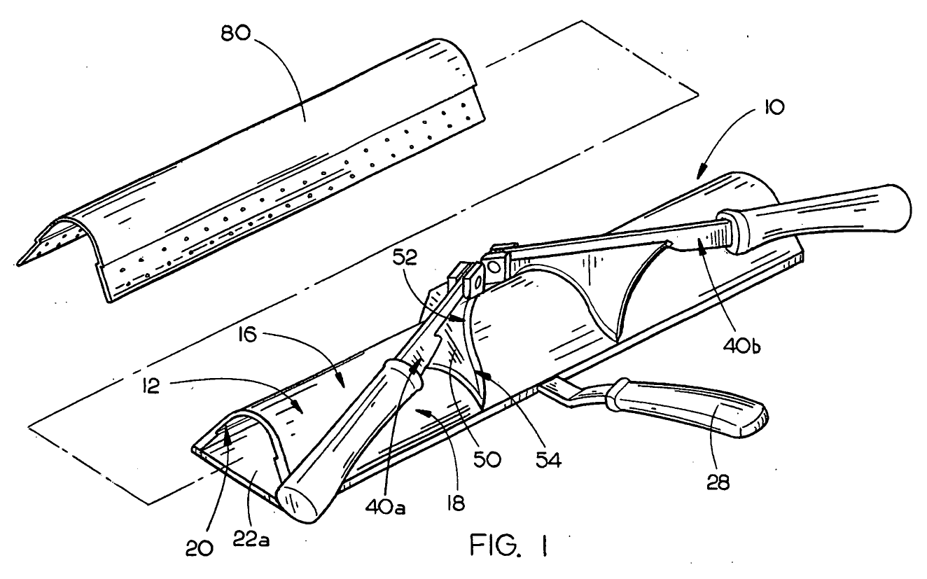

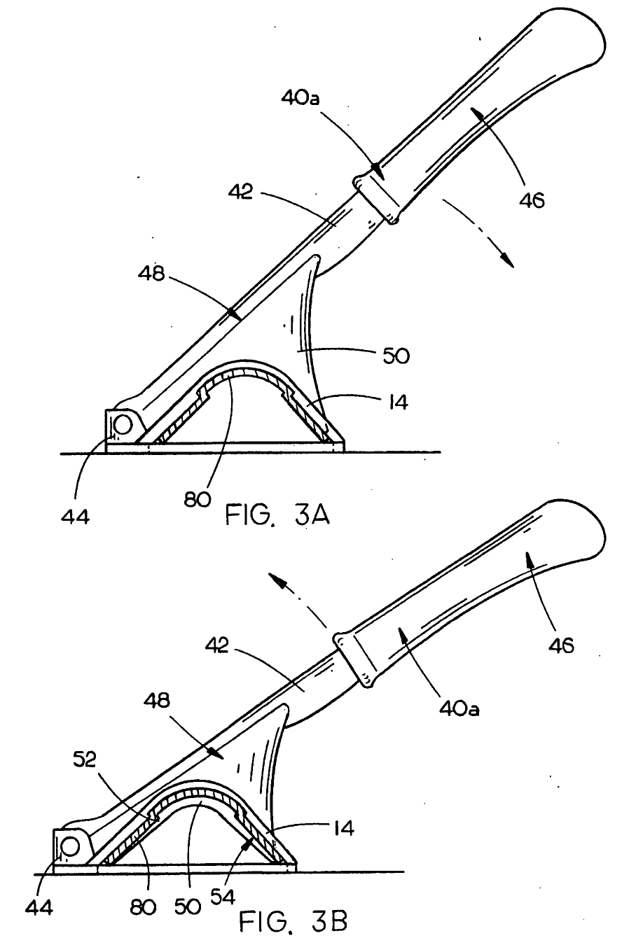

The drywall corner bead cutting device 10 of the present invention is shown best in FIGS. 1-3 as including a drywall corner bead retaining body 12 and two cutting blade assemblies 40a and 40b which are pivotably mounted on the retaining body 12 as will be described later in this disclosure. In the preferred embodiment, the retaining body 12 would include a longitudinally extended top wall plate 14 having a length of approximately 6 to 12 inches and a width of approximately 1 to 4 inches, and the top wall plate 14 would preferably be constructed of a sturdy sheet metal or the like. Top wall plate 14 preferably includes three integrally connected sections, a top section 16 having a generally arcuate cross-sectional shape, a lower inner wall plate section 18 extending downwards and inwards from the top section 16 and a lower outer wall plate section 20 which extends downwards and outwards from the top section 16 as shown best in FIGS. 1 and 3. In the preferred embodiment, lower inner wall plate section 18 and lower outer wall plate section 20 would extend generally perpendicular to one another, and the entire top wall plate 14 is specifically designed to closely approximate the general shape of the drywall corner bead 80 which is to be fit within the retaining body 12 as shown best in FIGS. 1 and 3a. Of course, it should be noted that the curvature of top section 16 and relative lengths of lower inner wall plate section 18 and lower outer wall plate section 20 to top section 16 may be modified or changed depending upon the specific type of drywall corner bead 80 which is intended to be cut by the drywall corner bead cutting device 10 of the present invention, and such modifications would be understood by one skilled in the art of metal object fabrication. It should also be noted that an exact duplication of the curvature and/or shape of drywall corner bead 80 is not strictly necessary to permit the present invention to function correctly, although it is preferred that a reasonable approximation of the shape of drywall corner bead 80 be incorporated into the cross-sectional shape of top wall plate 14 as has been described above.

Mounted on, extending between and connecting the lower edges of lower inner wall plate section 18 and lower outer wall plate section 20 of top wall plate 14 are a pair of base plates 22a and 22b which, in the preferred embodiment, would be positioned adjacent opposite ends of the top wall plate 14 and extend approximately one fifth to one third of the length of top wall plate 14 thus leaving a central opening 24 between the base plates 22a and 22b. For structural strength purposes, it is preferred that the retaining body 12 be constructed as including these base plates 22a and 22b, however, it should be noted that the use of any appropriate inner and outer base wall retention devices such as generally horizontal projecting metal strips mounted on each of the lower ends of lower inner wall plate section 18 and lower outer wall plate section 20 may be substituted for the base plates 22a and 22b as described above so long as the intended purpose and functionality of retaining the drywall corner bead 80 within the retaining body 12 is maintained. Such substitution of equivalent drywall corner bead retaining elements should be understood to be within the scope of this description. Also, it should be noted that the center opening 24, while preferred to be part of the present invention, is not critical to the functionality of the present invention as it is merely designed to permit the cut off section of the drywall corner bead 80 to fall downwards out of the retaining body 12 to facilitate use of the drywall corner bead cutting device 10 of the present invention.

Finally, mounted on and extending forwards from the retaining body 12 is a pivot mount support plate 26 which provides a support structure for the pivot mounts for the cutting blade assemblies 40a and 40b. Also, mounted on and extending outwards from the retaining body 12 is a handle 28 which is designed to provide an easy-to-grasp location for supporting the retaining body 12 of the drywall corner bead cutting device 10 of the present invention. Of course, the positioning, size and shape of the handle 28 may be modified or changed as necessary to facilitate use of the drywall corner bead cutting device 10 of the present invention, and it may be expedient to position the handle 28 in such a manner that use of the cutting blade assemblies 40a and 40b is facilitated to render the cutting of the drywall corner bead 80 even easier by use of the present invention.

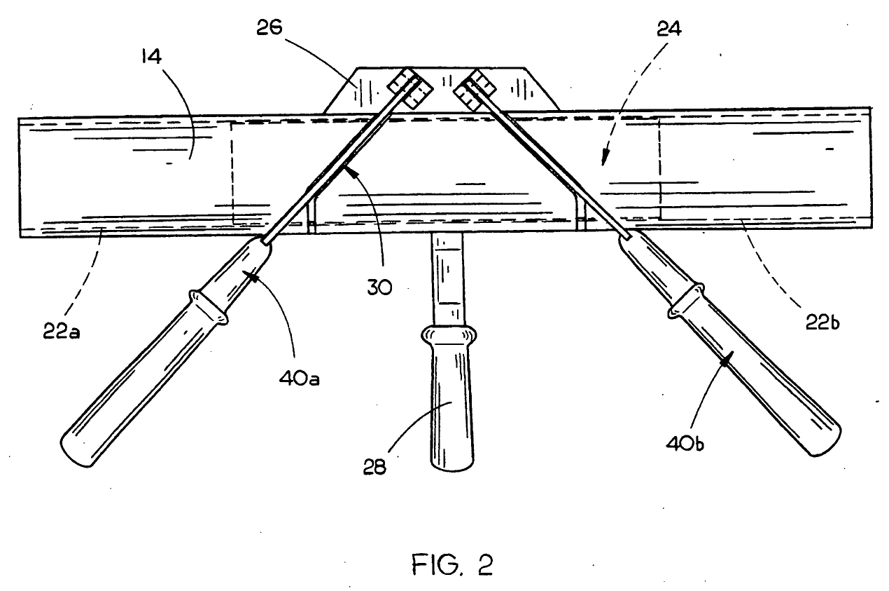

The cutting blade assemblies 40a and 40b are each pivotally mounted on the pivot mount support plate 26 of retaining body 12 as shown best in FIGS. 1 and 2. As each of the cutting blade assemblies 40a and 40b are generally identical to one another, except in terms of the curvature of the cutting blade which is reversed in each opposite cutting blade assembly 40a and 40b, the following description of cutting blade assembly 40a should be understood to apply equally to cutting blade assembly 40b. Cutting blade assembly 40a preferably includes a handle 42 which is pivotally mounted on pivot mount support plate 26 by a pivot block 44 having a pin extending therethrough which retains the mounted end of handle 42 therebetween to allow the handle 42 to pivot up and down relative to the pivot block 44. The handle 42 preferably further includes an outer gripping section 46 and an inner blade mounting section 48 on which the cutting blade 50 is mounted. In the preferred embodiment, cutting blade 50 is positioned such that it is generally aligned with a generally diagonal cutting slot 30 formed in top wall plate 14 of retaining body 12 as shown best in FIG. 2. This permits the cutting blade 50 to extend into the interior of retaining body 12 as shown best in FIGS. 3a and 3b, thus permitting the cutting blade 50 to engage the drywall corner bead 80 housed within the retaining body 12 for cutting thereof. In the preferred embodiment, the cutting blade 50 would be pivotable away from the retaining body 12 as shown in FIG. 3a and towards and into the retaining body 12 as shown in FIG. 3b via movement of handle 42. As can best be seen in FIG. 3b, when the handle 42 is pivoted downwards, the cutting blade 50 extends into the interior volume of the retaining body 12 thus cutting drywall corner bead 80 in a precise and efficient manner each and every time the drywall corner bead cutting device 10 is used.

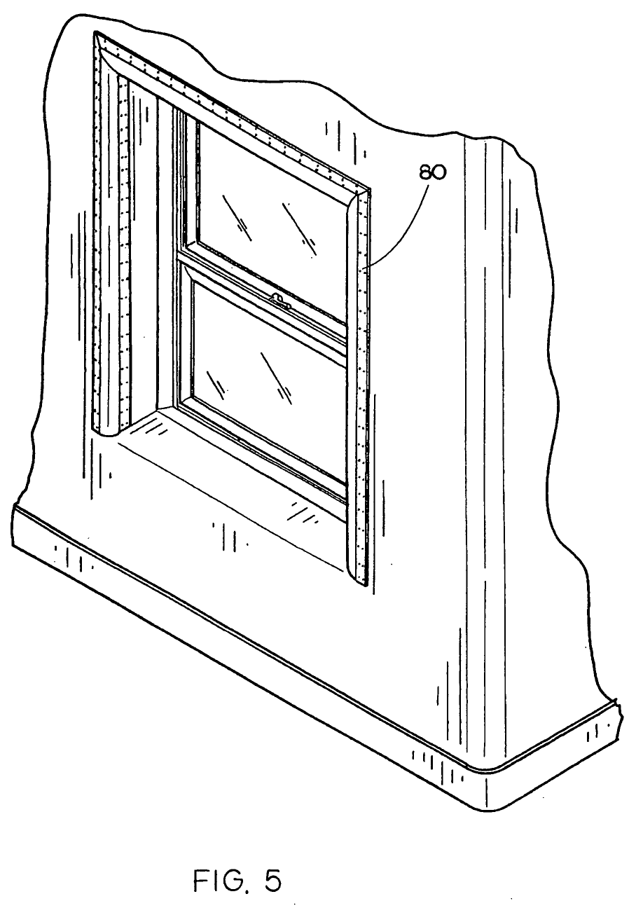

An important feature of the cutting blade 50 of the present invention is shown best in FIG. 2 in that the forward part 52 of cutting blade 50 extends generally parallel with handle 42 at approximately a 45° angle to the longitudinal axis of the retaining body 12. However, the outer portion 54 of cutting blade 50 extends generally perpendicular to the longitudinal axis of retaining body 12 in order to cut the outer straight portion of drywall corner bead 80 in a straight, generally perpendicular cut. As shown best in FIG. 5, this cut shape is necessary to provide a correct fit for two sections of drywall corner bead 80 which abut one another at the ends thereof, as the curved top portion of drywall corner bead 80 includes a diagonal cut whereas the side faces of the drywall corner bead 80 connect in a perpendicular arrangement. Of course, it is not strictly necessary that cutting blade 50 be formed in this manner, but it is important to the correct functioning of the present invention that corner bead 80 be cut in as precise a manner as possible to permit adjacent sections of drywall corner bead 80 to abut one another with very little gap therebetween.

An additional feature of the cutting blade assembly 40a of the present invention is that the cutting blade 50 may be constructed to be removable and replaceable from handle 42, and specifically blade mounting section 48 of handle 42, such that when a cutting blade 50 becomes dull or is damaged, it may be quickly and easily replaced to permit the drywall corner bead cutting device 10 of the present invention to continue to function correctly. Also, the cutting blade 50 may be constructed of any appropriate cutting materials, although it is preferred that a razor blade-like cutting blade be used with the present invention in order to provide consistently accurate and repeatable cutting results.

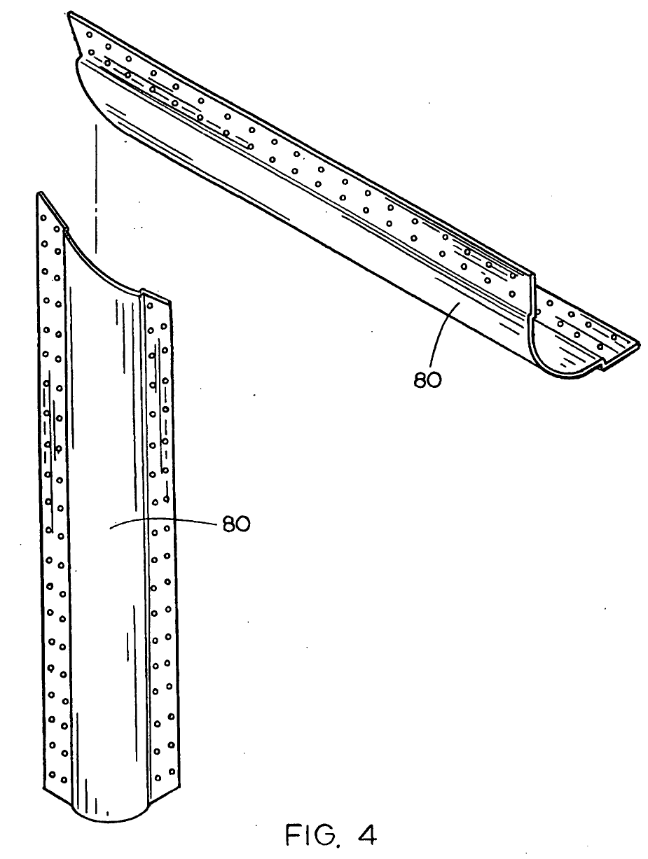

The present invention would be used in the following manner. Once the measurements are taken by the drywaller as to the proper lengths of the sections of drywall corner bead 80, the drywall corner bead 80 is cut to the approximate length of the section and the end of the rough cut drywall corner bead 80 is inserted into the retaining body 12 of the drywall corner bead cutting device 10 of the present invention until the rough cut drywall corner bead 80 is positioned where the cut should take place. The handle 42 of the cutting blade assembly 40 is then lowered to force the cutting blade 50 into contact with the rough cut drywall corner bead 80 through the generally diagonal cutting blade slot 30. By forcing the handle 42 downwards, the cutting blade 50 is driven down and through the rough cut drywall corner bead 80 thus cutting the rough cut drywall corner bead 80 in the desired location and producing an accurate and dependable cut in the rough cut drywall corner bead 80 which will permit the drywall corner bead 80 to be positioned and abut the adjacent section of drywall corner bead 80 surrounding the window, as shown in FIGS. 4 and 5. The handle 42 is then moved upwards removing the cutting blade 50 from contact with the drywall corner bead 80, the end portion of the drywall corner bead 80 falls downwards through central opening 24 for discarding thereof, and the cut drywall corner bead 80 is then removed from the retaining body 12. It should be noted that due to the cross-sectional shape of the retaining body 12 being generally similar to the cross-sectional shape of the drywall corner bead 80, lateral movement of the drywall corner bead 80 is restricted which ensures an accurate and clean cut of the drywall corner bead 80 by the cutting blade 50 each time the present invention is used. The drywall corner bead cutting device 10 is then ready for the next section of drywall corner bead 80 to be inserted for sectioning. The speed and relative ease of use of the present invention is thus clearly shown.

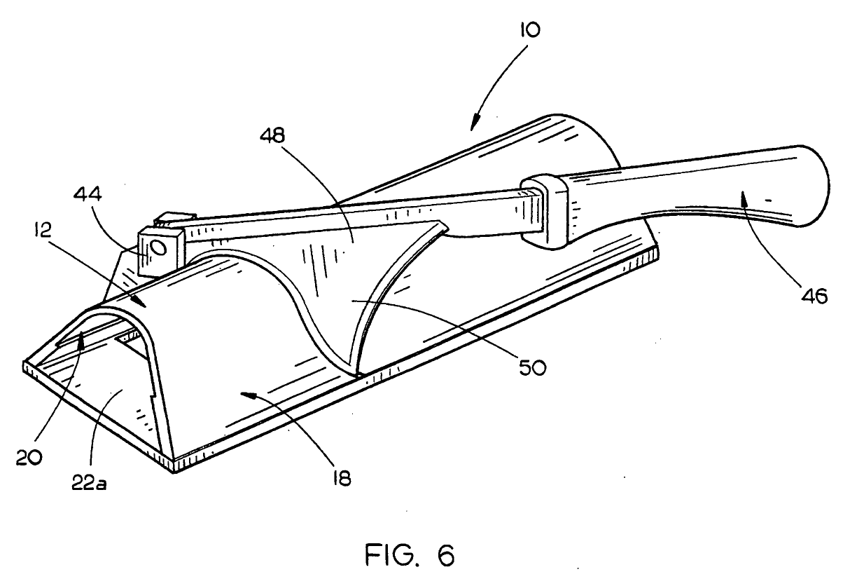

Finally, FIG. 6 discloses an alternative embodiment of the present invention which includes only a single cutting blade 50 for making either left or right-hand cuts to the drywall corner bead 80. The embodiment of FIG. 6 would be used in the manner described above, but it has been found that the use of such a simplified version of the present invention may be beneficial in that the simplified version is easier to carry and is smaller than the embodiment of FIG. 1. The only disadvantage is that the simplified version would require the user to have two separate units for performing cuts on the drywall corner bead 80, one for left-hand cuts and one for right-hand cuts, but depending on the user, such a requirement may be offset by the increased ease of use and improved transport capabilities of the simplified version of FIG. 6.

It is to be understood that numerous additions, modifications and substitutions may be made to the drywall corner bead cutting device 10 of the present invention which fall within the intended broad scope of the appended claims. For example, the precise angle at which cutting blade assemblies 40a and 40b are mounted may be modified or changed depending upon the angle of cut desired, and accordingly the shape of cutting blade 50 would be likewise modified to accommodate a different angle of cut. Such modifications would be necessary if one were to use the present invention to make cuts intended for 30°, 45° or even 60° angles surrounding windows, the occurrence and use of which is becoming more and more popular. Also, the specific size, shape and construction materials used in connection with the present invention may be modified or changed depending upon the needs of the user and/or manufacturer of the present invention and so long as such modifications do not significantly degrade or destroy the functional features of the present invention, they should be understood to be part of the present specification. Finally, it should be noted that the specific design features of the drywall corner bead cutting device 10 of the present invention may be modified or changed to accommodate various sizes and shapes of drywall corner beads as are commonly found in the industry, and such modifications would be understood by one skilled in the art of metal fabrication.

There has therefore been shown and described a drywall corner bead cutting device 10 which accomplishes at least all of its intended objectives.

I claim:

1. A drywall corner bead cutting device comprising:
a drywall corner bead retaining body including;
a longitudinally extended top wall plate having a longitudinal axis, a top section having a generally arcuate cross-sectional shape, a lower inner wall plate section extending downwards and inwards from said top section and a lower outer wall plate section extending downwards and outwards from said top section, said lower inner and lower outer wall plate sections extending generally perpendicular to one another such that said top wall plate has a cross-sectional shape generally similar to the cross-sectional shape of a drywall corner bead;
inner base wall retention means mounted on said lower inner wall plate section generally adjacent the lower portion thereof and generally extending towards said lower outer wall plate section; and
outer base wall retention means mounted on said lower outer wall plate section generally adjacent the lower portion thereof and generally extending towards said lower inner wall plate section;
at least one cutting blade assembly movably mounted on said drywall corner bead retaining body, said at least one cutting blade assembly including;
handle means movably mounted on said retaining body and having a gripping section and a blade mounting section positioned generally adjacent said top wall plate of said retaining body;
a cutting blade mounted on said blade mounting section of said handle means, said cutting blade being generally diagonally aligned relative to said longitudinally extended top wall plate; and
said cutting blade of said at least one cutting blade assembly operative to cut a drywall corner bead extended into said drywall corner bead retaining body via movement of said handle means to drive said cutting blade into and through a drywall corner bead to divide the drywall corner bead.

2. The drywall corner bead cutting device of claim 1 wherein said top wall plate further comprises at least one generally diagonal cutting blade slot formed in said top wall plate and extending therethrough.

3. The drywall corner bead cutting device of claim 1 wherein said inner base wall retention means and said outer base wall retention means jointly comprise at least one base plate mounted on, extending between and connecting the lower edges of said lower inner wall plate section and said lower outer wall plate section of said top wall plate.

4. The drywall corner bead cutting device of claim 1 further comprising a retaining body support handle mounted on said retaining body and extending outwards therefrom.

5. The drywall corner bead cutting device of claim 1 wherein said at least one cutting blade assembly is pivotably mounted on said drywall corner bead retaining body.

6. The drywall corner bead cutting device of claim 4 wherein said cutting blade further comprises a forward part extending generally parallel with said handle means at approximately a 45° angle to the longitudinal axis of said retaining body and an outer portion extending generally perpendicular to the longitudinal axis of said retaining body, said outer portion of said cutting blade operative to cut the outer straight wall of a drywall corner bead in a cut generally perpendicular to the longitudinal axis of said retaining body.

7. The drywall corner bead cutting device of claim 1 further comprising two cutting blade assemblies each mounted generally perpendicular to one another and extending generally diagonally to said longitudinal axis of said top wall plate.

8. A drywall corner bead cutting device comprising:
a drywall corner bead retaining body including;
a longitudinally extended top wall plate having a longitudinal axis, said top wall plate having a generally rounded L-shaped cross-sectional shape with a top section having a generally arcuate cross-sectional shape, a lower inner wall plate section and a lower outer wall plate section;
at least one base plate mounted on, extending between and connecting the lower edges of said lower inner wall plate section and said lower outer wall plate section of said top wall plate, said at least one base plate operative to cooperate with said top wall plate to releasably retain a drywall corner bead therein;
at least one cutting blade assembly movably mounted on said drywall corner bead retaining body, said at least one cutting blade assembly including a cutting blade mounted thereon, a forward portion of said cutting blade being generally diagonally aligned relative to said longitudinal axis of said top wall plate and a rearward portion of said cutting blade being generally perpendicularly aligned relative to said longitudinal axis of said top wall plate, said at least one cutting blade assembly operative to extend into said retaining body for cutting of drywall corner bead releasably retained therein; and
said cutting blade of said at least one cutting blade assembly operative to cut a drywall corner bead extended into said drywall corner bead retaining body via movement of said cutting blade into a drywall corner bead to divide the drywall corner bead.

9. The drywall corner bead cutting device of claim 8 wherein said top wall plate further comprises at least one generally diagonal cutting blade slot formed in said top wall plate and extending therethrough, said cutting blade slot having a shape generally approximating the shape of said cutting blade such that said cutting blade is extendable into said retaining body for cutting of drywall corner bead releasably retained therein.

10. The drywall corner bead cutting device of claim 8 further comprising a pair of said base plates positioned adjacent opposite ends of said top wall plate each extending approximately one fifth to one third of the length of said top wall plate thus leaving a central opening between said pair of base plates.

11. The drywall corner bead cutting device of claim 8 further comprising a retaining body support handle mounted on said retaining body and extending outwards therefrom.

12. The drywall corner bead cutting device of claim 8 further comprising two cutting blade assemblies each mounted generally perpendicular to one another and extending generally diagonally to said longitudinal axis of said top wall plate.

13. The drywall corner bead cutting device of claim 8 wherein said cutting blade has a lower cutting blade edge shape approximating the cross-sectional shape of said top wall plate.
